(19) United States
(12) Patent Application Publication
(10) Pub. No.: US 2006/0061607 A1
(43) Pub. Date: Mar. 23, 2006

(54) Method for facilitating swath height compensation for a printhead

(76) Inventors: Michael Anthony Marra III, Lexington, KY (US); Randall David Mayo, Georgetown, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/946,292

(22) Filed: Sep. 21, 2004

(51) Int. Cl. B41J 25/308

(52) U.S. Cl. 347/8

(57) ABSTRACT

A method for facilitating swath height compensation for a printhead includes determining a nominal swath height for a printhead class; determining a swath height of a printhead belonging to the printhead class; determining a calibration value for the printhead based on a deviation of a swath height of the printhead from the nominal swath height, the calibration value being used to determine a compensated media feed amount for an imaging apparatus; and storing the calibration value in a memory associated with the printhead.

### BACKGROUND OF THE INVENTION

1. Field of the Invention

The present invention relates to an imaging apparatus, and, more particularly, to a method for facilitating swath height compensation for a printhead installed in an imaging apparatus, such as an ink jet printer.

2. Description of the Related Art

An imaging apparatus in the form of an ink jet printer typically forms an image on a sheet of print media by ejecting ink from at least one ink jet printhead to place ink dots on the sheet of print media. Such an ink jet printer typically includes a reciprocating printhead carrier that transports one or more ink jet printheads across the sheet of print media along a bi-directional scanning path defining a print zone of the printer. The bi-directional scanning path is oriented parallel to a main scan direction, also commonly referred to as the horizontal direction. During printing on each scan of the printhead carrier, the sheet of print media is held stationary. A sheet feed mechanism is used to incrementally advance the sheet of print media in a sheet feed direction, also commonly referred to as a sub-scan direction, through the print zone between scans in the main scan direction, or after all data intended to be printed on the sheet of print media at a particular stationary position has been completed.

For a given stationary position of the sheet of print media, printing may take place during unidirectional or bi-directional scans of the printhead carrier. The height of the printhead generally defines a printing swath as ink is deposited on the sheet of print media during a particular scan of the printhead carrier. A printing swath is made of a plurality of printing lines traced along imaginary rasters, the imaginary rasters being spaced apart in the sheet feed direction, e.g., vertically on the printed page. In order to form the pattern of ink drops on the sheet of print media, a rectilinear array, also known as a matrix, of possible pixel, i.e., drop, locations is defined within the printable boundaries of the sheet of print media. The closest possible spacing of ink drops in the main scan direction is typically referred to as the horizontal resolution, and the closest possible spacing of ink drops in the sub-scan direction, i.e., between adjacent rasters, is typically referred to as the vertical resolution.

It has been observed that the media feed rate with respect to a particular printhead can cause printing defects, such as grain, horizontal banding, and color variations. For example, when a solid area fill includes multiple swath boundaries, horizontal bands may be visible. Swath height bands are caused by swath heights in excess of nominal (swath expansion) visualized as overlapping dots at the swath interface. Swath heights less than nominal (swath contraction) are visualized as having white line gaps between swaths.

One technique used to mask such printing defects is commonly referred to as shingling. Shingling causes consecutive printing swaths to overlap and only a portion of the ink drops for a given print line, i.e., raster, are applied to the sheet of print media on a given pass of the printhead. It has now been recognized that printing results may be improved by matching the media feed rate to the printhead swath height.

What is needed in the art is a method for facilitating swath height compensation for a printhead installed in an imaging apparatus, wherein the media feed rate is matched to the printhead swath height.

### SUMMARY OF THE INVENTION

The present invention provides a method for facilitating swath height compensation for a printhead installed in an imaging apparatus, wherein the media feed rate is matched to the printhead swath height.

The invention, in one form thereof, is directed to a method for facilitating swath height compensation for a printhead, including determining a nominal swath height for a printhead class; determining a swath height of a printhead belonging to the printhead class; determining a calibration value for the printhead based on a deviation of a swath height of the printhead from the nominal swath height, the calibration value being used to determine a compensated media feed amount for an imaging apparatus; and storing the calibration value in a memory associated with the printhead.

The invention, in another form thereof, is directed to an imaging apparatus. The imaging apparatus includes a print engine including a feed roller unit having a feed roller for transporting a sheet of print media by a media feed amount, and a printhead carrier for mounting a printhead for printing on the print media. The printhead has associated therewith a memory that stores a calibration value for the printhead that is based on a deviation of a swath height of the printhead from a nominal swath height. A controller is communicatively coupled to the print engine. The controller executes program instructions to retrieve the calibration value from the memory and use the calibration value to determine a compensated media feed amount for the imaging apparatus when imaging with the printhead.

The invention, in still another form thereof, is directed to a printhead cartridge. The printhead cartridge includes a printhead and a memory. The memory stores a calibration value for the printhead that is based on a deviation of a swath height of the printhead from a nominal swath height. The calibration value is used to adjust a media feed amount associated with an imaging apparatus utilizing the printhead.

One advantage of the present invention is that the occurrence of printing defects, such as grain, horizontal banding, and/or color variations, may be reduced.

Another advantage is that the printhead size tolerances may be less closely controlled, thereby resulting in less rejection of printheads during manufacture.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic depiction of a system embodying the present invention.

FIG. 2 shows a more detailed diagrammatic depiction of the print engine of the imaging apparatus of FIG. 1.

FIG. 3 is an exemplary depiction of one of the printheads of FIG. 1, with the printhead being projected over a sheet of print media to illustrate the concept of a swath associated with the printhead.

FIG. 4 is a flowchart depicting a method for facilitating swath height compensation for a printhead installed in the imaging apparatus of FIG. 1, in accordance with the present invention.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

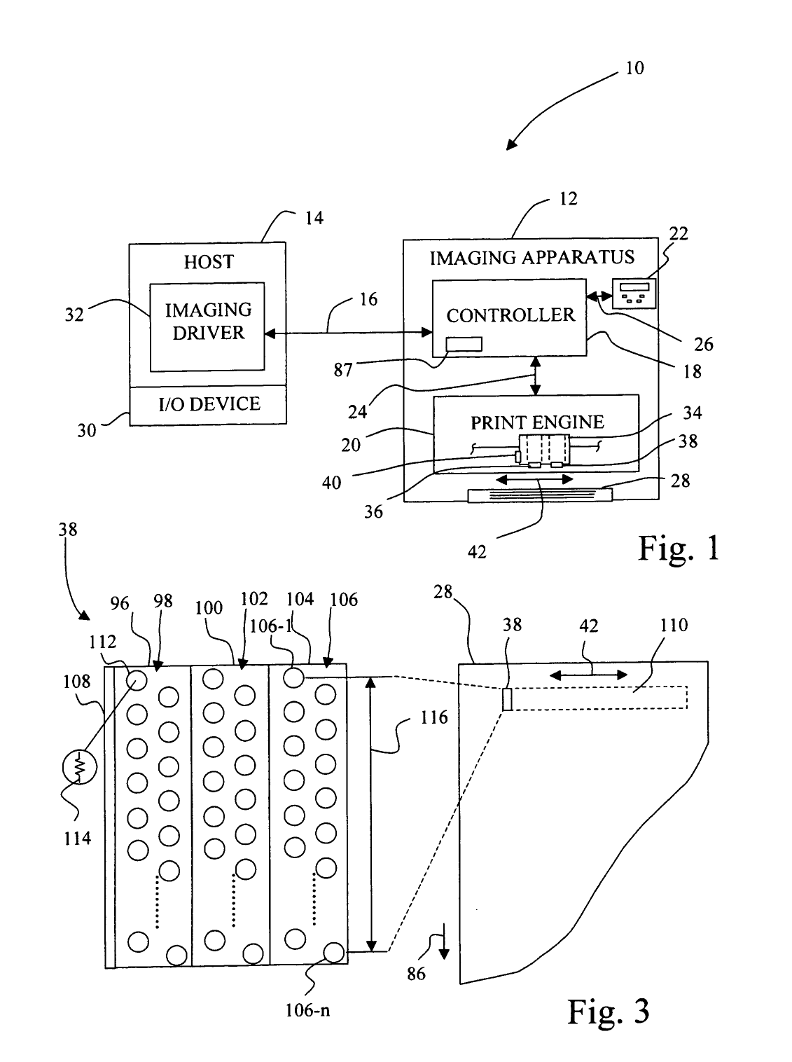

FIG. 1 is a diagrammatic depiction of a system 10 embodying the present invention. System 10 may include an imaging apparatus 12 and a host 14, with imaging apparatus 12 communicating with host 14 via a communications link 16. As used herein, the term “communications link” is used to generally refer to structure that facilitates electronic communication between two components, and may operate using wired or wireless technology.

Alternatively, imaging apparatus 12 may be a standalone unit that is not communicatively linked to a host, such as host 14. For example, imaging apparatus 12 may take the form of a multifunction machine that includes standalone copying and facsimile capabilities, in addition to optionally serving as a printer when attached to a host, such as host 14.

Imaging apparatus 12 may be, for example, an ink jet printer and/or copier. Imaging apparatus 12 includes, for example, a controller 18, a print engine 20 and a user interface 22.

Controller 18 includes a processor unit and associated memory, and may be formed as an Application Specific Integrated Circuit (ASIC). Controller 18 communicates with print engine 20 via a communications link 24. Controller 18 communicates with user interface 22 via a communications link 26.

In the context of the examples for imaging apparatus 12 given above, print engine 20 may be, for example, an ink jet print engine configured for forming an image on a sheet of print media 28. Print media sheet 28 may be, for example, plain paper, coated paper, photo paper and transparency media.

Host 14 may be, for example, a personal computer including an input/output (I/O) device 30, such as keyboard and display monitor. Host 14 further includes a processor, input/output (I/O) interfaces, memory, such as RAM, ROM, NVRAM, and a mass data storage device, such as a hard drive, CD-ROM and/or DVD units. During operation, host 14 includes in its memory a software program including program instructions that function as an imaging driver 32, e.g., printer driver software, for imaging apparatus 12. Imaging driver 32 is in communication with controller 18 of imaging apparatus 12 via communications link 16. Imaging driver 32 facilitates communication between imaging apparatus 12 and host 14, and may provide formatted print data to imaging apparatus 12, and more particularly, to print engine 20.

Alternatively, however, all or a portion of imaging driver 32 may be located in controller 18 of imaging apparatus 12. For example, where imaging apparatus 12 is a multifunction machine having standalone capabilities, controller 18 of imaging apparatus 12 may include an imaging driver configured to support a copying function, and/or a fax-print function, and may be further configured to support a printer function. In this embodiment, the imaging driver facilitates communication of formatted print data, as determined by a selected print mode, to print engine 20.

Communications link 16 may be established by a direct cable connection, wireless connection or by a network connection such as for example an Ethernet local area network (LAN). Communications links 24 and 26 may be established, for example, by using standard electrical cabling or bus structures, or by wireless connection.

Print engine 20 may include, for example, a reciprocating printhead carrier 34, at least one ink jet printhead, and in this example, includes a printhead 36, a printhead 38, and a reflectance sensor 40. Printhead carrier 34 transports ink jet printheads 36, 38 and reflectance sensor 40 in a reciprocating manner in a bi-directional main scan direction 42 over an image surface of the sheet of print media 28 during printing and/or sensing operations. Printhead carrier 34 may be mechanically and electrically configured to mount, carry and facilitate one or more printhead cartridges, such as for example, a monochrome printhead cartridge 44 and/or a color printhead cartridge 46. Each printhead cartridge 44, 46 may include, for example, an ink reservoir containing a supply of ink, to which printheads 36, 38 are respectively attached. In order for print data from host 14 to be properly printed by print engine 20, the rgb data generated by host 14 is converted into data compatible with print engine 20 and printheads 36, 38.

In one system using cyan, magenta, yellow and black inks, for example, printhead carrier 34 may carry four printheads, with each printhead carrying a nozzle array dedicated to a specific color of ink, e.g., cyan, magenta, yellow and black. As a further example, a single printhead, such as printhead 38, may include multiple ink jetting arrays, with each array associated with one color of a plurality of colors of ink, and printhead carrier 34 may be configured to carry multiple printheads.

Print engine 20 may further include a feed roller unit 48, a sheet picking unit 50, a mid-frame 52, and a media source 54.

Media source 54 is configured to receive a stack of print media sheets 56 from which a sheet of print media 28, is picked by sheet picking unit 50 and transported to feed roller unit 48, which in turn further transports print media sheet 28 during a printing operation.

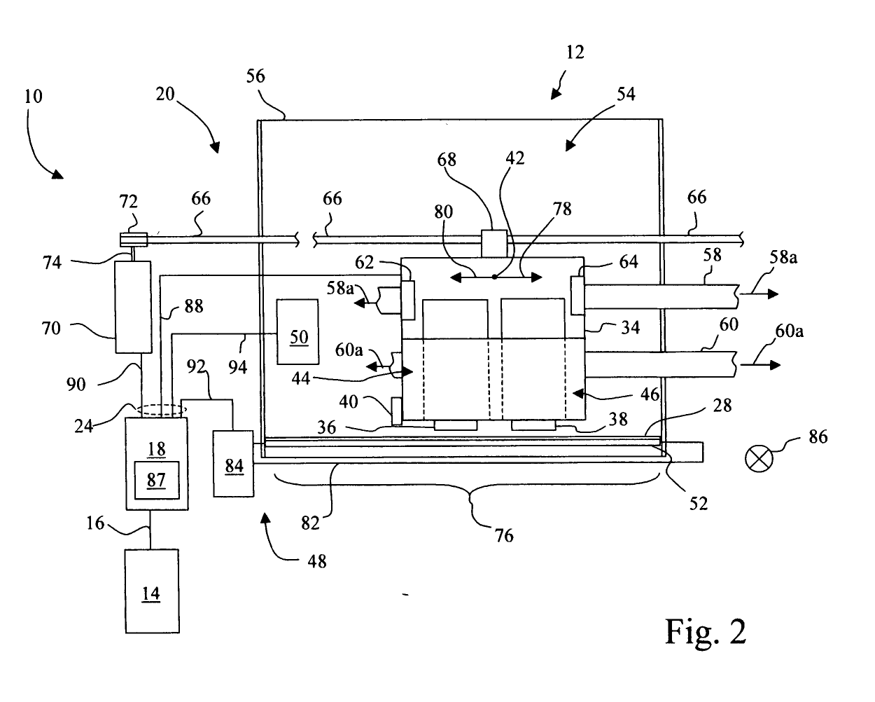

Referring now also to FIG. 2, printhead carrier 34 is guided by a pair of guide members 58, 60, such as guide rods. Each of guide members 58, 60 includes a respective horizontal axis 58a, 60a. Printhead carrier 34 may include a pair of guide rod bearings 62, 64, each of guide rod bearings 62, 64 including a respective aperture for receiving guide member 58. Printhead carrier 34 may further include a glide surface (not shown) that is retained in contact with guide member 60, for example, by gravitational force, or alternatively, by another guide rod bearing or bearing set. The horizontal axis 58a of guide member 58 is substantially parallel to main scan direction 42. Accordingly, main scan direction 42 is associated with each of printheads 36, 38.

Printhead carrier 34 is connected to a carrier transport belt 66 via a carrier drive attachment device 68. Carrier transport belt 66 is driven by a carrier motor 70 via a carrier pulley 72. Carrier motor 70 has a rotating carrier motor shaft 74 that is attached to carrier pulley 72. At the directive of controller 18, printhead carrier 34 is transported in a reciprocating manner along guide members 58, 60. Carrier motor 70 can be, for example, a direct current (DC) motor or a stepper motor.

The reciprocation of printhead carrier 34 transports ink jet printheads 36, 38 across the sheet of print media 28, such as paper, along main scan direction 42 to define a print zone 76 of imaging apparatus 12. The reciprocation of printhead carrier 34 occurs bi-directional along main scan direction 42, and includes a left-to-right carrier scan direction 78 and a right-to-left carrier scan direction 80. Generally, during each scan of printhead carrier 34 while printing, the sheet of print media 28 is held stationary by feed roller unit 48.

Mid-frame 52 provides support for the sheet of print media 28 when the sheet of print media 28 is in print zone 76, and in part, defines a portion of a print media path of imaging apparatus 12.

Feed roller unit 48 includes a feed roller 82 and corresponding index pinch rollers (not shown). Feed roller 82 is driven by a drive unit 84. The index pinch rollers apply a biasing force to hold the sheet of print media 28 in contact with respective driven feed roller 82. Drive unit 84 includes a drive source, such as a stepper motor, and an associated drive mechanism, such as a gear train or belt/pulley arrangement. Feed roller unit 48 feeds the sheet of print media 28 in a sheet feed direction 86, designated as an X in a circle to indicate that the sheet feed direction is out of the plane of FIG. 1 toward the reader. The sheet feed direction 86 is commonly referred to as the vertical direction, which is perpendicular to the main scan direction 42, and in turn, perpendicular to the carrier scan directions 78, 80. Thus, with respect to sheet of print media 28, carrier reciprocation occurs in a horizontal direction and media advance occurs in a vertical direction, and the carrier reciprocation is generally perpendicular to the media advance.

Controller 18 includes a microprocessor and associated memory 87, such as random access memory (RAM) and read only memory (ROM). Controller 18 executes program instructions to effect the printing of an image on the sheet of print media 28, such as for example, by selecting the index feed distance of the sheet of print media 28 along the print media path as conveyed by feed roller 82, controlling the reciprocation of printhead carrier 34, and controlling the operations of printheads 36, 38.

Controller 18 is electrically connected and communicatively coupled to printheads 36, 38 via a communications link 88. Controller 18 is electrically connected and communicatively coupled to carrier motor 70 via a communications link 90. Controller 18 is electrically connected and communicatively coupled to drive unit 84 via a communications link 92. Controller 18 is electrically connected and communicatively coupled to sheet picking unit 50 via a communications link 94.

FIG. 3 shows one exemplary configuration of printhead 38, which includes a cyan nozzle plate 96 including a nozzle array 98, a yellow nozzle plate 100 including a nozzle array 102, and a magenta nozzle plate 104 including a nozzle array 106, for respectively ejecting cyan (C) ink, yellow (Y) ink, and magenta (M) ink. In addition, printhead 38 may include a memory 108 for storing information relating to printhead 38 and/or imaging apparatus 12. For example, memory 108 may be formed integral with printhead 38, or may be attached to printhead cartridge 46. For convenience, and ease of discussion, memory 108 may also sometimes be referred to as printhead memory 108.

As further illustrated in FIG. 3, printhead carrier 34 is controlled by controller 18 to move printhead 38 in a reciprocating manner in main scan direction 42, with each left to right, or right to left movement of printhead carrier 34 along main scan direction 42 over the sheet of print media 28 being referred to herein as a pass. The area traced by a printhead, such as printhead 38, over sheet of print media 28 for a given pass will be referred to herein as a swath, such as for example, swath 110 as shown in FIG. 3.

In the exemplary nozzle configuration for ink jet printhead 38 shown in FIG. 2, each of nozzle arrays 98, 102, 106 includes a plurality of ink jetting nozzles 112, with each ink jetting nozzle 112 having at least one corresponding heating element 114. As within a particular nozzle array, or as from one nozzle array in comparison to another, the nozzle sizes of the plurality of ink jetting nozzles may vary from a nominal nozzle size due to variations which occur during manufacture of the printhead nozzle plate, e.g., nozzle plates 96, 100, 104, respectively, that includes the respective nozzle array. For example, where nozzle plates 96, 100, 104 are formed from a polyimide or other plastic material, such variation in nozzle diameter may result from the technique used to form the nozzle openings in the nozzle plate, such as for example, through the use of laser ablation in forming the ink jetting nozzles 112 in the polyimide nozzle plate.

A swath height 116 of swath 110 corresponds to the distance between the uppermost and lowermost of the nozzles within an array of nozzles of printhead 38, e.g., nozzles 106-1 and 106-n of nozzle array 106. In this example, the swath height 116 is the same for each of nozzle arrays 98, 102, and 106; however, this may not be the case, i.e., it is possible that the swath heights of nozzle arrays 98, 102, and 106 may be different, either by design or due to manufacturing tolerances. Furthermore, there may be variations in actual swath height from a nominal swath height for printheads within a particular printhead class. A printhead class may be, for example, a group of printheads having the same operational and/or design specification, e.g., a group of printheads having the same model number.

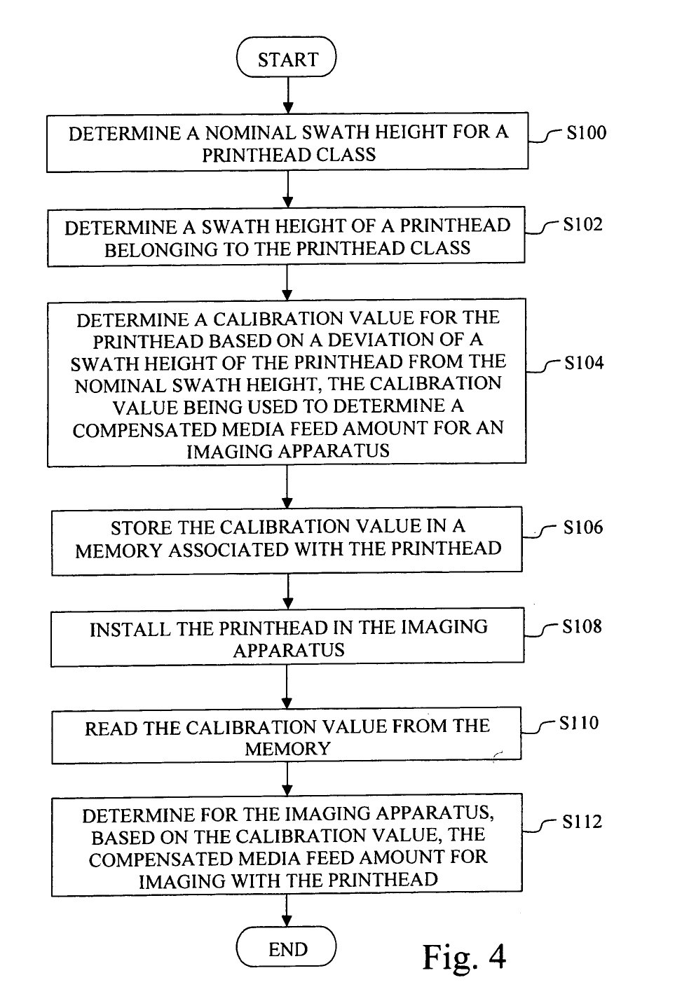

FIG. 4 is a flowchart depicting a method for facilitating swath height compensation for an exemplary printhead, e.g., printhead 38, installed in imaging apparatus 12 of FIG. 1, in accordance with the present invention.

At step S100, a nominal swath height for a printhead class is determined. The nominal swath height for a printhead class may be determined, for example, from the design specifications for the printhead class. Alternatively, the nominal swath height for the printhead class may be determined by averaging test measurements obtained for the swath heights of a plurality of printheads in the printhead class.

At step S102, a swath height of a printhead belonging to the printhead class is determined. In this example, reference will be made to printhead 38. In the case of printhead 38, which includes cyan nozzle array 98, yellow nozzle array 102 and magenta nozzle array 106, the swath height may be considered to be the same for all the arrays, or may be individually determined and each considered separately.

The swath height 116 of printhead 38 may be determined, for example, by a manufacturer associated with printhead 38, e.g., the manufacturer of printhead 38 and/or the manufacturer that assembles printhead cartridge 46. For example, the manufacturer may measure a distance between the uppermost and lowermost of the nozzles within an array of nozzles of printhead 38, e.g., nozzles 106-1 and 106-n of nozzle array 106. Alternatively, the manufacturer may determine the swath height 116 of printhead 38 by printing a swath, such as swath 110 of FIG. 3, with a test fixture and then measuring the printed swath height. The test fixture may be in the form of an imaging apparatus, such as imaging apparatus 12, which prints swath 110 and then uses controller 18 and reflectance sensor 40 to calculate the swath height 116 based on the printed results.

Alternatively, the swath height 116 of printhead 38 may be determined by a user of imaging apparatus 12, as an ink jet printer, by printing a swath, such as swath 110 of FIG. 3, and then sensing and calculating the swath height 116 using reflectance sensor 40 and controller 18.

At step S104, a calibration value for printhead 38 is determined based on a deviation of a swath height of printhead 38 from the nominal swath height for the printhead class. The calibration value will be used to determine a compensated media feed amount for the imaging apparatus in which printhead 38 is installed, such as for example, in imaging apparatus 12.

At step S106, the calibration value is stored in a memory associated with the printhead. In this example, the calibration value will be stored in memory 108 of printhead 38. Where the calibration value is determined by the manufacturer, the calibration value may be stored in memory 108 of printhead 38 by the manufacturer. Alternatively, where the calibration value is determined by the user, the calibration value may be stored in memory 108 of printhead 38 automatically by imaging apparatus 12.

At step S108, printhead 38 is installed in an imaging apparatus, such as for example imaging apparatus 12, for use during imaging.

At step S110, the calibration value is read from memory 108. In this example, controller 18 executes program instructions to accesses memory 108 and to retrieve the calibration value from memory 108.

At step S112, based on the calibration value, controller 18 executes program instructions to determine the compensated media feed amount for imaging with printhead 38 in imaging apparatus 12. The compensated media feed amount is further determined by consideration of an imaging apparatus specific media feed amount associated with at least one print mode of a plurality of print modes of imaging apparatus 12, prior to compensation using the calibration value. The imaging apparatus specific media feed amount may be determined, for example, by the manufacturer of imaging apparatus 12 and stored in memory 87 for later use by controller 18. Controller 18 then adjusts the imaging apparatus specific media feed amount based on the calibration value.

In one embodiment, for example, controller 18 may match the calibration value for printhead 38 to a particular compensated media feed amount of a plurality of media feed amounts stored in memory 87 associated with imaging apparatus 12. More particularly, controller 18 may use the calibration value as a pointer to a lookup table in memory 87 containing a plurality of media feed amounts so as to select an appropriate compensated media feed amount associated with a particular print mode of imaging apparatus 12.

While this invention has been described with respect to exemplary embodiments of the present invention, those skilled in the art will recognize that the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for facilitating swath height compensation for a printhead, comprising:
determining a nominal swath height for a printhead class;
determining a swath height of a printhead belonging to said printhead class;
determining a calibration value for said printhead based on a deviation of a swath height of said printhead from said nominal swath height, said calibration value being used to determine a compensated media feed amount for an imaging apparatus; and
storing said calibration value in a memory associated with said printhead.

2. The method of claim 1, wherein said swath height of said printhead is determined by a manufacturer associated with said printhead.

3. The method of claim 1, wherein said swath height of said printhead is determined by a user of said imaging apparatus.

4. The method of claim 1, further comprising:
installing said printhead in said imaging apparatus;
reading said calibration value from said memory;
determining for said imaging apparatus, based on said calibration value, said compensated media feed amount for imaging with said printhead.

5. The method of claim 4, wherein said compensated media feed amount is further determined by:
determining an imaging apparatus specific media feed amount associated with at least one print mode of a plurality of print modes of said imaging apparatus, prior to compensation using said calibration value; and
adjusting said imaging apparatus specific media feed amount based on said calibration value.

6. The method of claim 5, wherein said imaging apparatus specific media feed amount is determined at a time of manufacture of said imaging apparatus and stored in a memory associated with said imaging apparatus.

7. The method of claim 1, wherein said calibration value for said printhead is matched to a particular compensated media feed amount of a plurality of media feed amounts stored in a memory associated with said imaging apparatus.

8. An imaging apparatus, comprising:
a print engine including a feed roller unit having a feed roller for transporting a sheet of print media by a media feed amount, and a printhead carrier for mounting a printhead for printing on said print media, said printhead having associated therewith a memory that stores a calibration value for said printhead that is based on a deviation of a swath height of said printhead from a nominal swath height; and
a controller communicatively coupled to said print engine, said controller executing program instructions to retrieve said calibration value from said memory and use said calibration value to determine a compensated media feed amount for said imaging apparatus when imaging with said printhead.

9. The imaging apparatus of claim 8, wherein said compensated media feed amount is further determined by:
determining an imaging apparatus specific media feed amount associated with at least one print mode of a plurality of print modes of said imaging apparatus, prior to compensation using said calibration value; and
adjusting said imaging apparatus specific media feed amount based on said calibration value.

10. The imaging apparatus of claim 8, further comprising a memory, said controller executing program instructions to match said calibration value for said printhead to a compensated media feed amount of a plurality of media feed amounts stored in said memory.

11. A printhead cartridge, comprising:
a printhead; and
a memory storing a calibration value for said printhead that is based on a deviation of a swath height of said printhead from a nominal swath height, said calibration value being used to adjust a media feed amount associated with an imaging apparatus utilizing said printhead.
